(19) United States
(12) Patent Application Publication
(10) Pub. No.: US 2009/0021006 A1
(43) Pub. Date: Jan. 22, 2009

(54) Coupler for coupling conduits in flow communication

(75) Inventor: Andrew Hobbs, Bray Park (AU)

Correspondence Address: Locke Lord Bissell & Liddell LLP;Attn: Michael Ritchie, Docketing, 2200 Ross Avenue, Suite # 2200, DALLAS, TX, 75201-6776, US

(73) Assignee: Plastec Australia Pty Ltd., Caloundra (AU)

(21) Appl. No.: 12/156,522

(22) Filed: Jun. 2, 2008

(30) Foreign Application Priority Data
Jun. 1, 2007 (AU) 20077902964

(51) Int. Cl. F16L 27/04; B21K 1/16

(52) U.S. Cl. 285/276; 29/890.14

(57) ABSTRACT

A coupler 10 for coupling two conduits 12, 14 is disclosed. The coupler 10 includes a female open ended tubular member 16 and a male open ended tubular member 18. Each tubular member 16, 18 has a joint end 20 and a conduit connection end 22, 24 between which an axial flow path extends. The conduit connection end 22, 24 is for connecting the tubular member to an end of a conduit such as a drain pipe. The coupler 10 further includes a jointing arrangement 34 for connecting the joint ends 20 of the tubular members 16, 18 to each other. The arrangement 34 includes a coaxial spigot formation 26 at the joint end of the male tubular member 18, and a coaxial socket formation 28 at the joint end of the female tubular member 16. The spigot formation 26 is received in spigot-socket fashion within the socket formation 28. The jointing arrangement 34 permits angular and rotational movement of the two tubular members 16, 18 relative to each other. The coupler 10 also includes a securing arrangement that is a collar member extending over the socket member for mechanically holding the two tubular members 16, 18 to each other so that they cannot be separated.

### FIELD OF THE INVENTION

This invention relates to couplers or pipe joints for coupling conduits in flow communication with each other. In particular, the invention relates to a coupler for coupling conduits which may be deflectable from their initial installation alignment, such as drainage pipes, in flow communication with each other. The invention also relates to a method of manufacturing a said coupler and a method of coupling and installing conduits, such as drainage pipes, in flow communication with each other using a coupler. The invention extends to a conduit installation which may be subjected to external forces imposed thereupon after installation. The invention further relates to a kit for installing conduits, such as drainage pipes, in flow communication with each other, which conduits may be deflectable from their initial installation alignment.

The Applicant has found that this invention has particular application, but not exclusive application, to underground drainage piping systems for domestic drainage systems, e.g. storm water and sewerage drain pipes that are received within the ground. It will therefore be convenient to hereinafter describe the invention with reference to this example application. However, the invention can also be employed on other conduit systems, including above ground conduit systems and conduit systems other than those related to domestic plumbing installations.

### BACKGROUND TO THE INVENTION

Conduits, such as drainage pipes for conveying fluids, e.g. liquids such as water, may be installed in a subterranean environment. For example, drainage pipes, such as sewerage pipes and storm-water pipes, may be received in the ground whether it is for aesthetic, safety, or other practical purposes. Drainage pipes may also be fixedly mounted to a structure, such as a domestic dwelling e.g. a detached or semi detached house or a high-rise building structure. The Applicant is aware of instances in which external forces can be imposed on or applied to pipes received within the ground. For example a settlement of soil and gravel enveloping the pipe within the ground may cause the application of a force to the pipe. Further reactive soils may expand and contract in response to conditions within the soils, particularly in response to changes in moisture content within the soil, and this expansion or contraction may cause the application of force to the pipe. Further the building structure to which the drainage pipes are mounted may move over time and this may also cause the application of a force to the pipe.

In such instances, these external forces imposed onto the installed drainage pipes may attempt to deflect the installed drainage pipes relative to each other from their initially installed alignment. This results in continuous stresses being applied to these drainage pipes and pipe-joints coupling the drainage pipes. In turn the continuous stresses on these drainage pipes may lead to cracking and breakage of the pipes and/or the pipe couplers or pipe joints installed inline with the pipes. This often results in the leakage of liquid, e.g. fluid exfiltration from the pipe and/or the entry of external matter, e.g. unwanted infiltration from the outside into the pipe. The exfiltration of waste or sewer water through pipe cracks or gaps of disjointed joints may lead to contamination of the surrounding ground water and waterways, and pose environmental or public health hazards, water wastage, and increase maintenance costs. Consequently when this happens the drainage pipes need to be repaired or replaced. This can be an arduous and time consuming task, particularly as the pipes are received within the ground and the surrounding ground needs to be excavated to provide access to the damaged pipe.

Clearly it would be advantageous if a contrivance could be devised for coupling conduits, in particular drainage pipes, in flow communication with each other in such a way as to relieve imposed stresses on the pipes and pipe joints.

### SUMMARY OF THE INVENTION

According to one aspect of the present invention there is provided a coupler for coupling two conduits, which coupler includes:
two open ended tubular members, each tubular member having a conduit connection end opposite a joint end between which an axial flow path extends, the conduit connection end being for connecting the tubular member in flow communication to an end of a conduit;
a jointing arrangement for connecting the joint ends of the tubular members to each other such that they are in flow communication with each other, which jointing arrangement permits angular movement (omni-lateral pivoting) and rotational movement (swiveling) of the two tubular members relative to each other; and
means associated with the jointing arrangement for fixing the two tubular members to each other whereby to resist detachment of the tubular members from each other while still permitting said movement.

The fixing means may fixedly secure the two tubular members to each other. The fixing means may have a mechanical design that holds the tubular members against separation from each other.

The two open ended tubular members may comprise two substantially circular cylindrical tubular members, one tubular member being a male tubular member and the other tubular member being a female tubular member as defined in more detail below.

The jointing arrangement may include a coaxial spigot formation defined at the joint end of the male tubular member, and may also include a coaxial socket formation defined at the joint end of the female tubular member, the spigot formation defined in the male member being received within the socket defined in the female member in spigot-socket fashion.

The socket formation may be in the form of a hollow frusto-spherical socket projecting coaxially from a circumferentially extending edge of the joint end of the female tubular member, the socket defining a mouth which is free of interference, and the socket formation defining a radially inwardly directed surface defining a socket sliding surface.

The spigot formation may extend radially outwardly away from the male tubular member. The spigot formation may also extend circumferentially around the male tubular member.

In one form the spigot formation may comprise a circumferentially extending rib projecting radially away from the male tubular member towards the joint end of the male tubular member. In this specification the term rib shall be defined broadly and may have a wide lateral extent or width and need not be of rectilinear configuration. In particular it shall not be limited to a formation with a narrow width or lateral extent.

The rib may be uniformly shaped, e.g. of uniform cross-sectional shape around its circumferential extent, and the rib may define an axial convexly curved sliding surface for sliding over the radially inwardly directed surface of the socket. The convexly curved sliding surface on the rib may have a radius of curvature conforming to that of the frusto-spherical socket so that it is complementary to the socket. Thus, the rib is coaxially receivable within the socket to mate snugly with the socket with their respective sliding surfaces continuously in abutment or sliding contact when the socket is operatively slid over the rib in ball-and-socket fashion to permit angular movement or swiveling movement of the male tubular member relative to the female tubular member.

The rib may be a spherical segment annulus, with its opposed annular faces facing in an axial direction and its radially outwardly facing zone defining the rib sliding surface.

It will be appreciated that the selection of a spherically shaped socket and a complementary shaped rib permits freedom of movement for the tubular members to pivot in any lateral direction, i.e. omni-laterally, similarly to a ball-and-socket joint. To this end, the transverse circular shape of the socket and rib further permits swiveling or rotation of the tubular members relative to each other in addition to a pivoting or angular movement of the tubular members relative to each other.

The jointing arrangement may include a sealing arrangement for sealing the tubular members to each other to resist the ingress of fluids or debris into the flow path defined through the tubular members. The sealing arrangement may include a seal mounted on either the male or female tubular member and extending circumferentially around the male member to seal the male member to the female member.

The seal may include a uniformly shaped recess or groove extending circumferentially along the radial outer edge of the rib, and a resilient sealing member, such as an O-ring seal, partly countersunk inside the recess for sliding interference with the sliding surface of the socket.

The fixing means associated with the jointing arrangement for fixing the two tubular members to each other may comprise a fixing formation that extends over the socket formation outside of the socket formation and includes a stop formation that extends radially inward to a sufficient extent to interfere with the socket formation on the female member and block its detachment from the male member when it is displaced in a direction away from the female member.

The fixing formation holds the socket formation to the spigot formation whilst still permitting the socket formation and the rib to slide and rotate relative to each other.

The fixing formation may include a collar member, at least a part of which is positioned adjacent to an outward facing surface of the socket formation in use. In particular a part of the collar member may bear against the socket formation proximate to the region at which the rib bears against the socket, e.g. the collar member may be axially positioned so that it is substantially aligned with the rib to provide support thereto in the region in which the rib bears against the socket formation.

The collar member may be generally circular cylindrical in shape comprising a generally flat major side wall and a circumferentially extending shoulder projecting radially inwardly from the side wall, towards one edge thereof. The shoulder may form the stop of the fixing formation. The radially inwardly projecting shoulder may be located, shaped and dimensioned to define an annular sliding gap between its radially inwardly facing edge and the sliding surface of the rib, through which gap a side wall of the socket passes operatively to slide along the gap with a small clearance. The small clearance may be a working clearance.

The coupler may also include means for mounting the collar member to the male tubular member having the spigot formation.

The mounting means may include a mounting shoulder extending radially outwardly from the male tubular member at its conduit connection end, and the collar member may be mounted on the mounting shoulder.

The male member may be formed integrally with the mounting shoulder and the mounting shoulder may be attached to the collar member, e.g. permanently by solvent or ultrasonic welding or adhesion. Instead the collar member may be formed integrally with the mounting shoulder and the mounting shoulder may be attached to the male member, e.g. permanently by solvent or ultrasonic welding or adhesion.

In another form the attachment shoulder may define a formation on its radially outer edge, thereby to attach with a complementary formation on a radially inner surface of the collar member. The one and complementary formations may be screw thread formations and the formations may be releasably or permanently attached to each other.

Thus, when the two tubular members and the collar member are assembled, an annular chamber is defined between opposed transverse surfaces of the collar member and the male tubular member, and opposed axial surfaces of the rib and the attachment shoulder, within which chamber an intruding portion of the side wall of the socket is free to move during pivoting and swiveling movement of the tubular members relative to each other.

Each tubular member may include a pipe connection arrangement at its conduit connection end for connecting the tubular member in flow communication to the conduit.

The pipe connection arrangement at the conduit connection end of each tubular member may include a coaxial socket formation for cooperating with a nipple or spigot formation provided at an end of the drainage conduit to which it is to be connected. Instead, the tubular member may include a coaxial nipple or spigot formation to cooperate with a socket formation at an end of the drainage conduit to which it is to be connected. The pipe connection arrangement may also include any conventionally available connection for sealingly connecting the one end of the tubular member to an associated end of the drainage conduit.

The tubular members and the collar member may each be of unitary construction formed from a synthetic plastics material, such as a thermoforming or thermoset plastics material. The tubular members and the collar member may be made by an injection moulding operation. The tubular members may be made from an engineering plastics material such as PVC (Polyvinylchloride) or ABS (Acrylonitrile Butadiene Styrene) or ASA (Acrylonitrile Styrene Acrylate). The material may also be an alloy of one or more of these compounds. The typical domestic drain pipe may have a diameter of about 60 to 160 mm and the tubular members may be similarly sized to be coupled thereto as described above. In one particular form the drain pipe may have a nominal diameter of 95 to 105 mm. In another form the drain pipe may have a nominal diameter of 145 to 155 mm.

According to another aspect of this invention there is provided a method of manufacturing a conduit coupler, including:
forming a male tubular member;
forming a female tubular member;
forming a fixing formation;
receiving the male member within the female member; and
mounting the fixing formation over the female member to form an assembled coupler in which the male and female members cannot be detached from each other.

The male and female members may be formed separately from each other. The fixing formation may be a collar member and may also be formed separately from the male and female members.

Each of the male and female members and the collar member may be formed integrally by a moulding operation, e.g. by an injection moulding operation. The collar member may be fixed to the male member, e.g. permanently, by means of solvent welding or ultrasonic welding.

The male member may be formed with an attachment shoulder integral therewith and the collar member may be permanently attached to the attachment shoulder by means of solvent or ultrasonic welding.

According to another aspect of this invention there is provided a coupler for coupling two conduits, which coupler includes:
an open ended substantially circular male tubular member and an open ended substantially circular female tubular member, each tubular member having a conduit connection end opposite a joint end between which an axial flow path extends, the conduit connection end being for connecting the tubular member in flow communication to an end of a conduit;
a jointing arrangement for connecting the joint ends of the tubular members in flow communication with each other, including a coaxial spigot formation defined at the joint end of the male tubular member, and a coaxial socket formation defined at the joint end of the female tubular member, the spigot formation defined in the male member being received within the socket formation defined in the female member in spigot-socket fashion, and a seal for sealing the spigot formation to the socket formation, which jointing arrangement permits angular and rotational movement of the two tubular members relative to each other; and
a collar member for fixing the male and female tubular members to each other whereby to resist detachment of the tubular members from each other while still permitting said movement.

The coupler may include any one or more of the optional features of the coupler defined above in the first aspect of the invention.

According to another aspect, the invention extends to a pipeline including at least one conduit coupler as defined in the first aspect of the invention in line with the pipeline.

The conduit coupler may include any one or more of the optional features of the conduit coupled defined above in the first aspect of the invention. The pipeline may further include an expansion joint that is expandable in an axial direction of the pipe that is coupled inline with the pipeline. The expansion joint may be spaced away from the conduit coupler in the direction of length of the pipeline.

According to a still further aspect of this invention there is provided a method of installing conduits, such as drainage pipes, which conduits may be deflected from their initial longitudinal axial alignment under the influence of external forces imposed thereupon, which method includes:
joining two tubular members with a jointing arrangement to connect the tubular members in flow communication, which jointing arrangement permits angular and rotational movement between the at least two tubular members relative to each other, wherein the jointing arrangement is fixed to resist the joint from coming apart during use; and
connecting an associated end of a conduit to an end of one tubular member and connecting an associated end of another conduit to an end of the other tubular member.

The step of joining the two tubular members with a jointing arrangement may include sealing the tubular members to each other to resist the leakage of fluids or debris out of the tubular members.

The conduits may be joined using a conduit coupler including two tubular members and a jointing arrangement as defined above in the first aspect of the invention. In particular the two tubular members and the jointing arrangement may include any one or more of the optional features in the first aspect of the invention described above.

The method may include connecting an expansion joint inline with one of the conduits, e.g. drainage pipeline, downstream or upstream of the jointing arrangement, the expansion joint permitting longitudinal expansion of the conduit, in use. The expansion joint may be coupled to the conduit adjacent to the jointing arrangement or it may be spaced away from the jointing arrangement along the conduit (pipeline).

The method may include laying the connected conduits, e.g. drainage pipeline, beneath the ground surface such that they are received within the ground.

The step of connecting an associated end of a conduit to an end of one tubular member may include providing the end of the tubular member with a socket or a nipple to cooperate with a nipple or a socket, as the case may be, provided on an end of the conduit.

According to yet a further aspect, the invention provides a combination of elements, e.g. a kit, for coupling conduits, such as drainage pipes, in flow communication with each other, the conduits being prone to deflection from its initial installation alignment, which kit includes a coupler as defined above.

The kit may include an expansion joint defining a flow path for installation inline with one of said conduits. The expansion joint may be telescopically extensible and compressible.

The kit may include a plurality of O-ring seals, and mounting formations such as a bracket, an elbow joint, a T-piece joint, and the like.

### DETAILED DESCRIPTION OF THE PREFERRED EMBODIMENTS

A coupler, in accordance with the invention, may manifest itself in a variety of forms. It will be convenient to hereinafter describe in detail a preferred embodiment of the invention with reference to accompanying diagrammatic drawings. The purpose of providing this detailed description is to instruct persons having an interest in the subject matter of the invention how to carry the invention into practical effect. However it is to be clearly understood that the specific nature of this detailed description does not supersede the generality of the preceding broad description.

In the accompanying diagrammatic drawings:

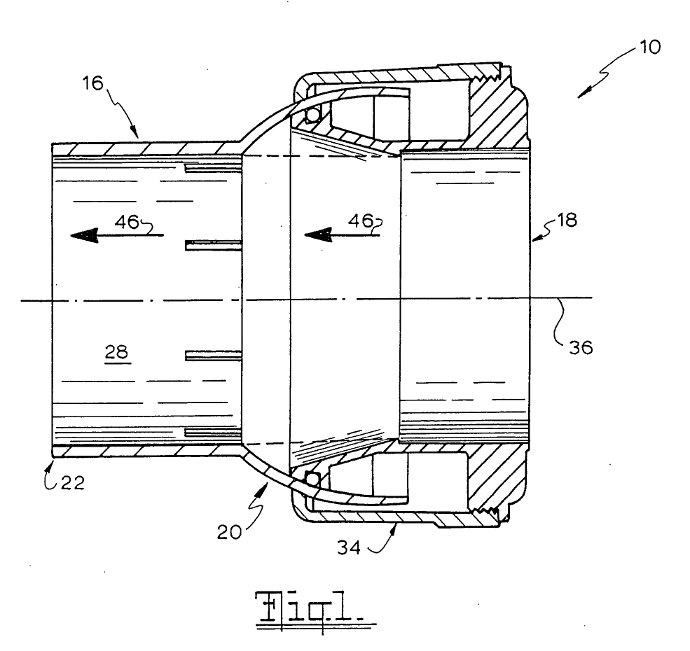

FIG. 1 shows a longitudinal sectional view of a coupler in accordance with the invention in one position;

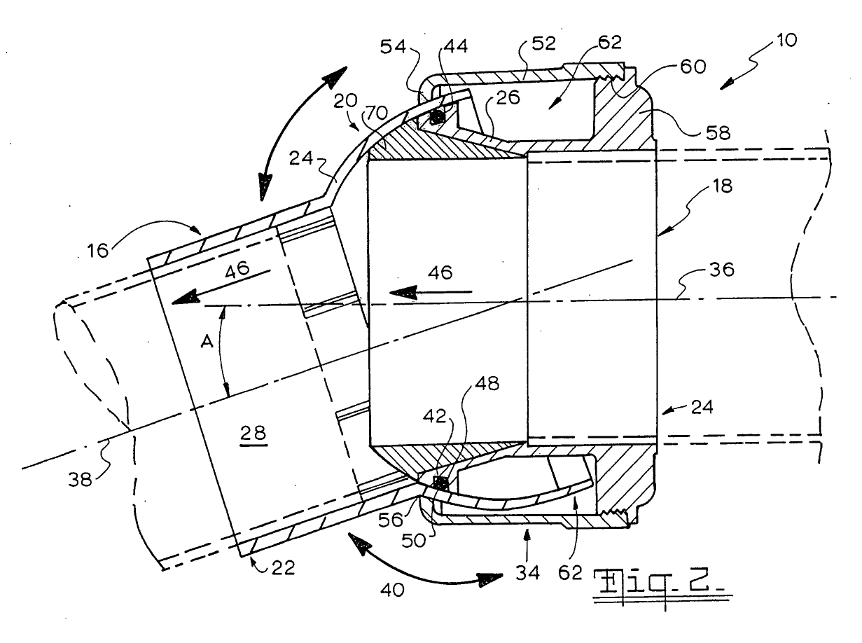

FIG. 2 shows a longitudinal sectional view of the coupler of FIG. 1 in another position;

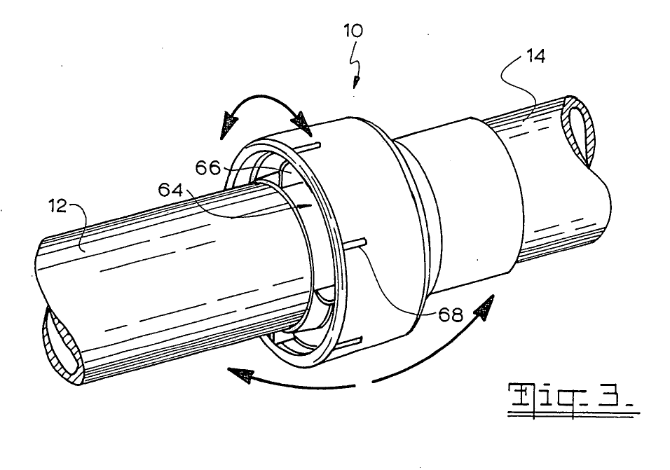

FIG. 3 shows a three-dimensional view of the coupler in FIG. 1 connected in-line with an upstream conduit and a downstream conduit;

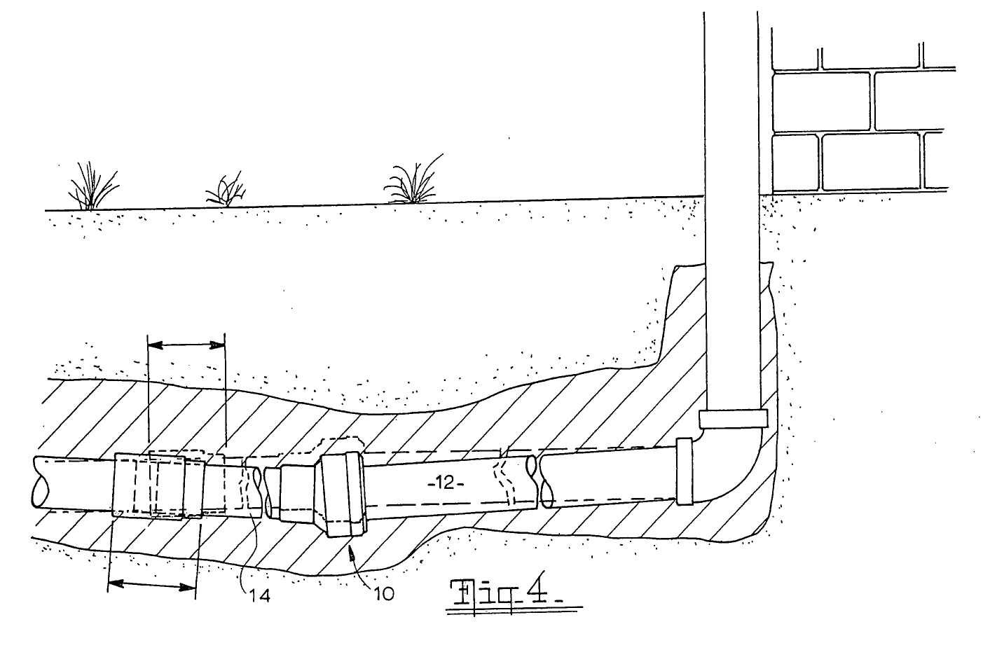

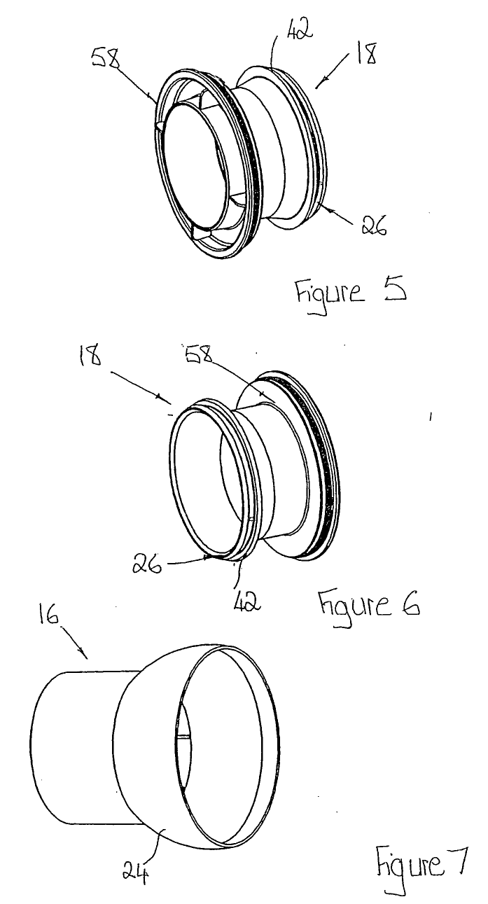

FIG. 4 shows a side elevational view of a pipe installation employing a coupler in accordance with the invention;

FIG. 5 is a three dimensional view of a male tubular member of the coupler when viewed from one end;

FIG. 6 is a three dimensional view of the male tubular member of FIG. 5 when viewed from the other end; and

FIG. 7 is a three dimensional view of a female tubular member of the coupler.

In the drawings, reference numeral 10 generally refers to a coupler, in accordance with the invention, for coupling conduits 12, 14 (see FIG. 4) in flow communication with each other. In this example as described and illustrated, the conduits 12, 14 are in the form of drainage conduits, particularly drainage pipes which extend away from a domestic dwelling and are buried in the ground.

The pipe coupler 10 includes two open ended tubular members 16, 18 having joint ends, at 20. Each tubular member 16, 18 has a pipe connection arrangement at its conduit connection end, at 22, 24, opposite its joint end, at 20, for connecting to an associated end of the drainage pipe 12, 14.

The two open ended tubular members 16, 18 are generally circular cylindrical in shape. The one tubular member 18 is a male tubular member and the other tubular member 16 is a female tubular member. The male tubular member 18 shown particularly in FIGS. 5 and 6 defines a spigot formation 26 at its joint end, at 20, and the female tubular member 16 shown particularly in FIG. 7 defines a socket formation 24 at its joint end, at 20, thereby to cooperate socket-spigot fashion with each other.

The conduit connection arrangement 22 of the female tubular member 16 is in the form of a coaxial pipe socket formation 28 for cooperating with a pipe nipple or spigot formation at the associated end of the downstream drainage conduit 12 (see FIG. 4). Similarly, the male tubular member 18 includes a pipe socket formation for connection to the nipple or spigot formation at the associated end of the upstream drainage conduit 14.

The coupler 10 also includes a jointing arrangement, generally indicated by reference numeral 34 to connect the joint ends, at 20, of the two tubular members in flow communication, which jointing arrangement 34 permits omni-lateral angular movement between the two tubular members relative to each other. Referring to FIGS. 1 and 2, longitudinal axes 36, 38 are shown respectively for tubular members 18 and 16. When the two tubular members are coaxially aligned, then the two axes 36, 38 coincide. However, in accordance with the invention, the two tubular members are angularly displaceable, in the direction of arrow 40, i.e. through an angle indicated by reference character A between axis 36 and axis 38 as shown in FIG. 2.

The jointing arrangement 34 includes the socket formation 24 and the spigot formation 26. The socket formation is in the form of a hollow frusto-spherical socket projecting coaxially from a circumferential end edge of the joint end, at 20, of the female tubular member 16. The frusto-spherical socket 24 is disposed such that its mouth end is free, and a radially inwardly directed surface of the socket 24 defines a socket sliding surface.

In this embodiment, the spigot or nipple formation 26 includes a uniformly shaped circumferentially extending rib 42 which projects radially outwardly from the joint end, at 20, of the male tubular member 18. The rib 42 defines an axially curved convex sliding surface having a radius of curvature complementary to that of the frusto-spherical socket 24. In other words, the rib is in the form of an annular spherical segment with its annular faces facing in an axial direction and its sliding surface being the segment zone.

The segment zone has a radius of curvature conforming to that of the spherical socket 24, so that the rib 42 is snugly received by the socket 24. The sliding surfaces of the socket 24 and rib 42 are continuously in abutment when the socket 24 is operatively slid over the rib 42 in ball-and-socket fashion to permit angular displacement or omni-lateral pivoting and swiveling, of the male tubular member 16 relative to the female tubular member 18.

Therefore, selection of a spherically-shaped socket 24 and a complementary shaped rib 42, permit freedom of movement of the tubular members 16, 18 in any angular direction and also swiveling of the tubular members 16, 18 relative to each other.

A sealing arrangement 44 including a seal also forms part of the jointing arrangement 34, for sealing off the flow path 46 defined through the tubular members 16, 18 from ingress and egress of fluids or debris. The sealing arrangement 44 comprises a uniformly shaped groove 48 recessed in the rib extending circumferentially around the rib 42, and a resilient sealing member 50 in the form of an O-ring seal which is partly countersunk inside the groove 48.

Further, the jointing arrangement 34 also includes a fixing formation in the form of a collar member 52 to fix the tubular members to each other while permitting the socket 24 and rib 42 to retain their sliding relationship. The collar member 52 is generally circular cylindrical in shape comprising a generally flat major side wall and a circumferentially extending shoulder 54 projecting radially inwardly from one end edge of its side wall. The radially inwardly projecting shoulder 54 forms a stop for stopping the female member from being pulled off the male member and thereby fixes the members to each other. The shoulder 54 is shaped and dimensioned to define an annular sliding gap, at 56, between its radially inwardly facing edge and the sliding surface of the rib 42. A side wall of the socket 24 passes operatively through the sliding gap 56 to slide with a working clearance over the rib 42.

The jointing arrangement 34 further includes an attachment shoulder 58 projecting radially outwardly from the conduit connecting end of the male tubular member 18 opposite its joint end, at 20. The attachment shoulder 58 defines some excess material on its radially outer edge, thereby to facilitate a permanent attachment to a radially inner surface of the collar member 52 by solvent welding, ultrasonic welding or the like.

Thus, an annular chamber, generally indicated by reference numeral 62, is defined between the transversely opposed surfaces of the collar member 52 and the male tubular member 18, and the axially opposed surfaces of the rib 42 and the attachment shoulder 58, within which chamber 62 the free end of the socket 24 is free to move during angular displacement, in the directions of arrow 40, of the tubular members 16, 18 relative to each other.

The male tubular member 18 defines an annular groove 64 in an axially outwardly directed side of the attachment shoulder 48, in which a plurality of equiangularly spaced apart gussets or fins 66 radiate across the groove 64, serving as gripping formations for a user. A plurality of equiangularly spaced elongated gripping formations 68 also protrude from an outer surface of the collar 52 further to facilitate gripping by a user.

The coupler 10 includes an insert member 70 having a body defining a radially inner surface which is dimensioned to be flush with the inner surface of the tubular members 16, 18, when they are axially aligned. A radially outer surface of the insert is contoured to nest in an irregularly contoured space defined between the socket 24 and the nipple or spigot formation 26. The insert member 70 fills in the irregular space defined by the male and female members thus preventing a built-up of debris or liquid in said irregular space.

In accordance with the invention, the coupler forms part of an apparatus or kit for installing conduits, such as the drainage pipes 12, 14. The apparatus includes the coupler 10 and often also an expansion joint 80. The expansion joint 80, in this illustration, is telescopically extendible and formed to be installed inline with one of the pipes 12, 14 to compensate for longitudinal expansion of the pipeline when the pipes 12, 14 are displaced out of their initial coaxial alignment as permitted by the coupler 10.

Generally the collar member is permanently mounted on the attachment shoulder on the male member. However in some forms the collar member may not be permanently attached to the attachment shoulder and the coupler 10 may conceivably be disassembled by screwing the collar member 52 off the attachment shoulder 58.

In use, and in accordance with the method of the invention, if a user couples two drainage pipes 12, 14 in flow communication, which drainage pipes 12, 14 would be received in the ground then a user couples the pipes 12, 14 with the coupler 10, as illustrated in FIG. 4. The expansion joint 80 is also installed inline one of the pipes 12, 14, e.g. at a point spaced away from the coupler. Once the pipes are buried, the settlement of soil and gravel enveloping the buried drainage pipes 12, 14 may impose an external force on the pipes 12, 14. For example if ground movement occurs this may impose a force on one of the drainage pipes, say pipe 12, which tends to displace one of the pipes 12 out of its co-axial alignment with the other pipe 14. With the coupler illustrated in the drawings the tubular member attached to the pipe 12 is free to move angularly or pivot relative to the other pipe 14 in the directions of arrow 40. However the pivotal movement effects an adjustment of the longitudinal length of the pipe. To accommodate this, the expansion joint 80 expands longitudinally to facilitate the pivoting in the manner indicated by arrows 82 and 84. An advantage of the coupler described above with reference to the drawings is that it forms an assembly in which the male tubular member cannot be pulled off and detached from the female tubular member. Thus it forms an assembly that is held together while permitting pivoting and rotational movement. This feature is useful because the coupler cannot then be disassembled either during installation or during use. A further advantage is that the assembly of the coupler is simple yet efficacious and is not prone to mechanical failure.

Another advantage of the coupler described above and illustrated in the drawings is that each tubular member can pivot through about 20 degrees. This provides a considerable range of movement which is advantageous. For example with this coupler one conduit could extend at an angle of 40 degrees to the other conduit and the coupler would be able to accommodate this range of movement.

Advantageously, the coupler 20 relieves torsion and bending stresses on the drainage pipes 12, 14, and on the coupler 10 and thus resists damage to the pipes as a result of the stresses. In turn this may prolong a working life of the pipe installation. Further, the pipes 12, 14 by being allowed to move relative to each other thus submit to external forces prior to cracking or rupturing, thereby reducing the likelihood of ingress or egress of liquid and other matter into or out of the flow path.

A further advantage of this coupler 10 is that it has a collar member 52 that has a return shoulder that is positioned over the point at which the male member 18 seals against the female member 16. This provides support at this point and helps to achieve efficacious sealing of the male member against the female member

A further advantage of this invention is that the male and female members 16, 18 and the collar 52 can be separately moulded as unitary articles in injection moulding operations. This enables the coupler 10 to be manufactured in large numbers in an injection moulding plant and be supplied to the market at a reasonable cost.

It will of course be realized that the above has been given only by way of illustrative example of the invention and that all such modifications and variations thereto, as would be apparent to persons skilled in the art, are deemed to fall within the broad scope and ambit of the invention as is herein set forth.

1. A coupler for coupling two conduits, which coupler includes:
two open ended tubular members, each tubular member having a conduit connection end opposite a joint end between which an axial flow path extends, the conduit connection end being for connecting the tubular member in flow communication to an end of a conduit;
a jointing arrangement for connecting the joint ends of the tubular members in flow communication with each other, which jointing arrangement permits angular and rotational movement of the two tubular members relative to each other; and
a fixing formation associated with the jointing arrangement for fixing the two tubular members to each other whereby to resist detachment of the tubular members from each other while still permitting said movement.

2. A coupler as claimed in claim 1, wherein the two open ended tubular members are substantially circular tubular members, one tubular member being a male tubular member and the other tubular member being a female tubular member.

3. A coupler as claimed in claim 2, wherein the jointing arrangement includes a coaxial spigot formation defined at the joint end of the male tubular member, and a coaxial socket formation defined at the joint end of the female tubular member, the spigot formation defined in the male member being received within the socket formation defined in the female member in spigot-socket fashion.

4. A coupler as claimed in claim 3, wherein the socket formation is in the form of a hollow frusto-spherical socket projecting coaxially from a circumferentially extending edge of the joint end of the female tubular member, the socket defining a mouth which is free of interference, and the socket formation defining a radially inwardly directed surface defining a socket sliding surface.

5. A coupler as claimed in claim 4, wherein the spigot formation is in the form of a circumferentially extending rib projecting radially outwardly from the joint end of the male tubular member, said rib being uniformly shaped and defining an axial convexly curved sliding surface for sliding over the radially inwardly directed surface of the socket.

6. A coupler as claimed in claim 5, wherein the convexly curved sliding surface on the rib has a radius of curvature conforming to that of the frusto-spherical socket.

7. A coupler as claimed in claim 5, and wherein the jointing arrangement includes a sealing arrangement for sealing the tubular members to each other to resist the ingress of fluids or debris into the flow path defined through the tubular members, and wherein the sealing arrangement includes a groove extending circumferentially along the radial outer edge of the rib, and a resilient sealing member partly countersunk inside the recess for sliding interference with the sliding surface of the socket.

8. A coupler as claimed in claim 5, wherein the fixing formation extends over the socket formation outside of the socket formation and includes a stop formation that extends radially inward to a sufficient extent to interfere with the socket formation on the female member and resist its detachment from the male member.

9. A coupler as claimed in claim 8, wherein the fixing formation includes a collar member at least a part of which is adjacent to an outward facing surface of the socket formation in use, and which is proximate to the region at which the rib bears against the socket to provide support thereto.

10. A coupler as claimed in claim 9, wherein the collar member is generally circular cylindrical in shape comprising a generally flat major side wall and a circumferentially extending shoulder projecting radially inwardly from the side wall, towards one edge thereof.

11. A coupler as claimed in claim 10, wherein the shoulder is located, shaped and dimensioned to define an annular sliding gap between its radially inwardly facing edge and the sliding surface of the rib, through which gap a side wall of the socket passes operatively to slide along the gap with nothing more than a working clearance.

12. A coupler as claimed in claim 10, wherein the collar member includes an attachment arrangement including an attachment shoulder projecting radially outwardly from the male tubular member at its conduit connection end, and the attachment shoulder is an arrangement for attaching the collar member thereto.

13. A coupler as claimed in claim 12, wherein the attachment shoulder is permanently attached to the collar member by solvent welding or ultrasonic welding.

14. A coupler as claimed in claim 1, wherein each tubular member includes a pipe connection arrangement at its conduit connection end for connecting the tubular member in flow communication to the conduit.

15. A coupler as claimed in claim 14, wherein the pipe connection arrangement at the conduit connection end of each tubular member includes a coaxial socket formation for cooperating with a nipple or spigot formation provided at an end of an existing conduit to which it is to be connected.

16. A coupler as claimed in claim 14, wherein the pipe connection arrangement at the conduit connection end of each tubular member includes a coaxial nipple or spigot formation for cooperating with a socket formation at an end of an existing conduit to which it is to be connected.

17. A method of installing conduits including the steps of:
joining two tubular members with a jointing arrangement to connect the tubular members in flow communication, which jointing arrangement permits angular and rotational movement between the at least two tubular members relative to each other, wherein the jointing arrangement is fixed to resist the joint from coming apart during use; and
connecting an associated end of a conduit to an end of one tubular member and connecting an associated end of another conduit to an end of the other tubular member.

18. A method of manufacturing a conduit coupler for coupling two conduits, including:
forming a male tubular member;
forming a female tubular member;
forming a fixing formation;
receiving the male member within the female member; and
mounting the fixing formation over the female member to form an assembled coupler in which the male and female members cannot be detached from each other.

19. A method according to claim 18, wherein the male and female members are each integrally formed separately from each other, and wherein the fixing formation is a collar member that is also integrally formed separate from the male and female members.

20. A method according to claim 19, wherein each of the male and female members and the collar member is integrally formed by a moulding operation, and wherein the collar member is permanently mounted on the male member.
